(19) United States
(12) Patent Application Publication
(10) Pub. No.: US 2013/0179495 A1
(43) Pub. Date: Jul. 11, 2013

(54) SYSTEM AND METHOD FOR ALERTING LEAKAGE OF PERSONAL INFORMATION IN CLOUD COMPUTING ENVIRONMENT

(71) Applicant: ELECTRONICS AND TELECOMMUNICATIONS RESEARCH INSTITUTE, Daejeon-si (KR)

(72) Inventors: Bo-Yun EOM, Daejeon-si (KR); Chang-Woo YOON, Daejeon-si (KR); Hyun-Woo LEE, Daejeon-si (KR); Won RYU, Daejeon-si (KR)

(73) Assignee: ELECTRONICS AND TELECOMMUNICATIONS RESEARCH INSTITUTE, Daejeon-si (KR)

(21) Appl. No.: 13/653,839

(22) Filed: Oct. 17, 2012

(30) Foreign Application Priority Data
Jan. 10, 2012 (KR) 10-2012-0003165

(51) Int. Cl. G06F 15/16

(52) U.S. Cl. 709/203

(57) ABSTRACT

There are provided a file management server for ensuring security in a cloud computing environment, and a file management method thereof. The file management server includes: a file registration unit configured to store a file in a plurality of chunk servers, and to manage a security level of the file; and a file search unit configured to receive a file access request from a client module, to check a security level of a file corresponding to the file access request, to notify, if the security level of the file is equal to or higher than a predetermined security level, the file's owner that a request for accessing the file has been made.

### CROSS-REFERENCE TO RELATED APPLICATION

This application claims the benefit under 35 U.S.C. §119(a) of Korean Patent Application No. 10-2012-0003165, filed on Jan. 10, 2012, the entire disclosure of which is incorporated herein by reference for all purposes.

### BACKGROUND

1. Field

The following description relates to a file management server for preventing data created by individuals and personal data from being misused in a distributed file system which is one of cloud computing technologies, and a file management method thereof.

2. Description of the Related Art

A cloud computing environment which provides IT resources as various kinds of services by connecting several servers through a network uses a virtualization technology for flexible provision of resources. The “virtualization” technology in cloud computing hides physical computing resources from users or other systems through software, and allows separation and/or integration of the computing resources. However, in a cloud computing environment using the virtualization technology, a user cannot recognize which server stores his or her personal information, who accesses his or her files, and when access to the files is made or the files leak. The problem brings anxiety about security to users who use cloud computing.

For data-based cloud computing that has to process massive data, a distributed file system has been used which distributes data into a plurality of servers and manages it in a distributed manner. A distributed file system for cloud computing has many similarities to a general distributed file system, and has been designed to be able to be distributed as low-cost hardware. Also, the distributed file system for cloud computing needs to have good fault-tolerance, excellent extensibility, and system stability through a method of storing data copies or the like.

A conventional cloud computing technology is disclosed in U.S. Laid-open Patent Application No. 2011/0072487A1, entitled “System, method, and software for providing access control enforcement capabilities in cloud computing systems”, laid-open on Mar. 24, 2011.

### SUMMARY

The following description relates to a file management server for allowing a user to recognize misuse of his or her file in a cloud computing environment, thereby improving reliability on the file management server, and a file management method thereof.

In one general aspect, there is provided a file management server including: a file registration unit configured to distributively store a file in a plurality of chunk servers, and to manage a security level of the file; and a file search unit configured to receive a file access request from a client module, to check a security level of a file corresponding to the file access request, to notify, if the security level of the file is equal to or higher than a predetermined security level, the file's owner that a request for accessing the file has been made.

In another general aspect, there is provided a file management method including: checking, if a file access request is received, a security level of a file corresponding to the file access request; and notifying, if the security level of the file is equal to or higher than a predetermined security level, the file's owner that a request for accessing the file has been made.

Other features and aspects will be apparent from the following detailed description, the drawings, and the claims.

### BRIEF DESCRIPTION OF THE DRAWINGS

FIG. 1 is a diagram illustrating an example of a personal information leakage alert system for ensuring the security of files in a cloud computing environment.

FIG. 2 is a diagram illustrating an example of a file management server of FIG. 1.

FIG. 3 is a diagram illustrating an example of a client module.

FIG. 4 is a flowchart illustrating a file storing process for ensuring the security of files in a cloud computing environment.

FIG. 5 is a flowchart illustrating a file read process for ensuring the security of file in a cloud computing environment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

In the following description, the meaning that a certain section “includes” a certain component will be interpreted as the meaning that the corresponding section can further include other components, as long as there is no description that the other components are excluded. Also, the terms “. . . part”, “. . . unit”, “. . . module”, etc. in the following description are units each of which processes at least one function or operation, and may be implemented as hardware, software, or a combination of hardware and software.

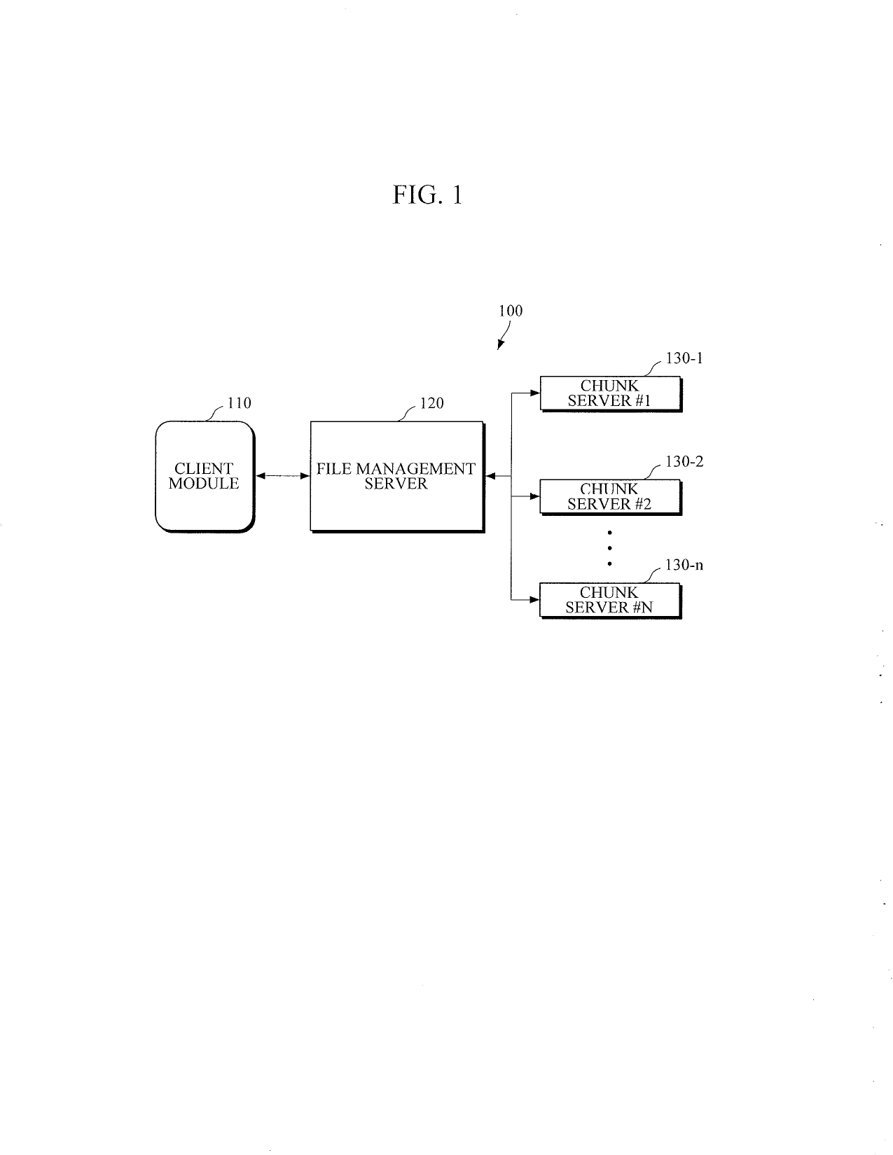

FIG. 1 is a diagram illustrating an example of a personal information leakage alert system 100 for ensuring the security of files in a cloud computing environment.

Referring to FIG. 1, the personal information leakage alert system 100 includes a client to module 110, a file management server 120, and a plurality of chunk servers 130-1 through 130-n.

The client module 110 may be one of various kinds of user terminals, such as a smart phone, a mobile phone, a personal computer, etc. There may be a plurality of client modules that can distributively store files using the file management server 120 and the plurality of chunk servers 130-1 through 130-n, although FIG. 1 shows a single client module 110.

The file management server 120 is connected to the client module 110 and the plurality of chunk servers 130-1 through 130-n through a network. The plurality of chunk servers 130-1 through 130-n represent a group of cloud servers that are used for cloud computing.

The client module 110 transfers a file that is to be distributively stored, to the file management server 120. Here, the file may be various kinds of data, and distributively stored by the file management server 120. At this time, information about the file's owner is represented as information (e.g. owner ID) for identifying an owner. If a file is received (or uploaded) from the client module 110, the file management server 120 may segment the received file in units of a predetermined size of chunk to generate a plurality of chunks, and distributively store the plurality of chunks in the plurality of chunk servers 130-1 through 130-n. The file management server 120 manages the locations at which a plurality of chunks for a single file are stored, in the form of metadata.

Meanwhile, if a file access request for accessing a specific file is received from the client module 110, the file management server 120 informs the client module 110 of the locations of chunk servers (for example, the chunk servers #1 130-1, #2 130-2, and #n 130-n) in which the corresponding file is to be distributively stored, and file storage information including chunk identification information stored in the corresponding chunk servers. The client module 110 may access the chunk servers #1 130-1, #2 130-2, and #n 130-n using the file storage information received from the file management server 120, and receive chunks corresponding to the chunk identification information from the chunk servers #1 130-1, #2 130-2, and #n 130-n. Then, the client module 110 may combine the chunks received from the chunk servers #1 130-1, #2 130-2, and #n 130-n to thereby restore the file that has been distributively stored in units of chunks.

As another method, the file management server 120 may use the locations of chunk servers (for example, the chunk servers #1 130-1, #2 130-2, and #n 130-n) that a file requested from the client module 110 has been distributively stored in units of chunks, and chunk identification information stored in the chunk servers #1 130-1, #2 130-2, and #n 130-n, to receive chunks from the chunk servers #1 130-1, #2 130-2, and #n 130-n, combine the chunks to restore the file, and then transmit the restored file to the client module 110.

Also, the file management server 120 may manage the security level of a file that is received from the client module 110 so that the file can be distributively stored. Files may be allocated different security levels, for example, security levels “high”, “middle”, and “low”. The security level of a file may be set by the client module 110 and transmitted to the file management server 120. Alternatively, the file management server 120 may analyze a file received from the client module 110 to allocate an appropriate security level to the file.

If it receives a file access request from the client module 110, the file management server 120 may check the security level of a file corresponding to the file access request, and notify, if the security level of the file is equal to or higher than a predetermined security level, the file's owner that a file access request has been made. For this, the file management server 120 may manage informant about owners of files, including contact information of the owners.

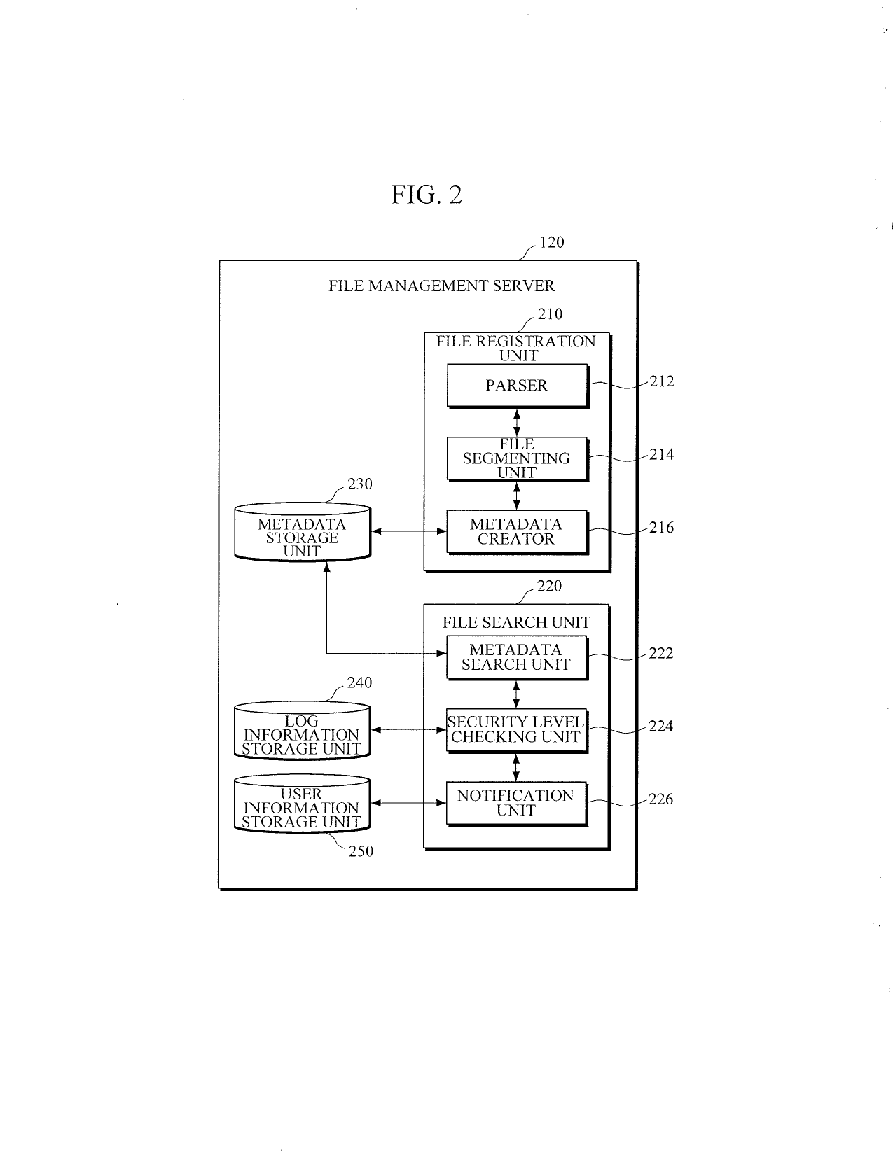

Hereinafter, a configuration for file security management among the functions of the file management server 120 will be described with reference to FIGS. 1 and 2.

Referring to FIGS. 1 and 2, the file management server 120 includes a file registration unit 210, a file search unit 220, a metadata storage unit 230, a log information storage unit 240, and a user information storage unit 250.

The file registration unit 210 receives a file requested to be stored from the client module 110, and distributively stores the file in the plurality of chunk servers 130-1 through 130-n. The file registration unit 210 manages the security levels of files.

The file search unit 220 may be configured to receive a file access request from the client module 110, to check the security level of a file corresponding to the file access request, and to notify, if the security level of the file is equal to or higher than a predetermined security level, the file's owner that a file access request has been made. The client module 110 may transmit a file access request for accessing a file which the client module of another user has uploaded to the file management server 120, as well as a file access request for accessing a file which the client module 110 has uploaded to the file management server 120, to the file management server 120.

The metadata storage unit 230 stores metadata including file IDs, security level information of received files, information about locations at which the received files have been distributively stored, and information about the received files' owners.

The log information storage unit 240 stores log information representing access information of files. The log information may include various kinds of information related to access of the files. For example, when a file is accessed as a file operation is performed, the file search unit 220 may store information related to the file as log information. In other words, the log information may include a path along which a file distributively stored in the chunk servers 130-1 through 130-n moves when access to the file has been made, a file access time, etc.

The user information storage unit 250 stores user information including contact information for each of the files' owners. The user information may include IDs and contact information about the files' owners. The contact information may include the phone numbers of the file owners' terminals (for example, mobile phones), the file owners' E-mail addresses, etc.

Hereinafter, the configurations and operation of the file registration unit 210 and the file search unit 220 will be described.

The file registration unit 210 may determine whether a received file has been allocated a security level, analyze, if the file has been allocated no security level, the file to determine whether the file includes a word corresponding to a security keyword, allocate an appropriate security level to the file according to the security keyword, and then manage the security level of the file. If the file has already been allocated a security level, the file registration unit 210 may manage the security level of the file.

Referring to FIG. 2, the file registration unit 210 may include a parser 212, a file segmenting unit 214, and a metadata creator 216.

If the received file has been allocated no security level, the parser 212 of the file registration unit 210 parses the received file. By parsing the file, the parser 212 may output the analysis result on whether at least one predetermined security keyword is extracted from the file (to drafter: please check it). The predetermined security keyword may include at least one keyword representing a degree of importance or a degree of sensitivity to security. If the analysis results indicate that at least one predetermined security keyword is extracted from the file, or if a predetermined number of security keywords or more are extracted from the file, the parser 212 may allocate a security level “high” to the file. The predetermined security keyword and the predetermined number of security keywords may be set by the user of the client module 110 or by a manager of the file management server 120.

Thereafter, the parser 212 may transfer the analysis results for allocating a security level to the received file, to the metadata creator 216.

The file segmenting unit 214 may allocate a security level to the file based on the analysis results received from the parser 212.

The file segmenting unit 214 may segment, as described above, the file in units of a predetermined size of chunk to generate a plurality of chunks, decide the locations of chunk servers at which the chunks are to be stored, and then transfer information about the security level of the file, segmentation information about the chunks into which the file has been segmented, and information about the locations of the chunk servers at which the chucks are to be stored, to the metadata creator 216.

The metadata creator 216 creates information related to the received file. That is, if the received file has already been allocated a security level, the metadata creator 216 may create metadata regarding the security level, also create the segmentation information about chunks into which the file has been segmented, the information about the locations of the chunk servers at which the chunks are to be stored, etc., as metadata, store the metadata in the metadata storage unit 230, and manage the metadata. The segmentation information may include information that will be used to restore the file, such as the ID of each chunk, size information of each chunk, etc.

If it receives a file access request, the file search unit 220 may search for metadata of the corresponding file from the metadata storage unit 230, in responses to the file access request, and checks the security level of the file based on the found metadata. The file search unit 220 may check, whenever it receives a file access request from the client module 110, the security level of the corresponding file from the metadata storage unit 230, in response to the file access request.

If the security level of the file is equal to or higher than a predetermined security level, the file search unit 220 searches for the file's owner from the user information storage unit 250, and notifies the file's owner that a request for accessing the file has been mad. The file search unit 220 may notify the file's owner that a file access request has been made, using a text message or E-mail.

If the security level of the file is lower than the predetermined security level, the file search unit 220 stores access information of the file as log information in the log information storage unit 240. If the file search unit 240 receives a log information access request from the client module 110 and determines that a user of the client module 110 is identical to the file's owner, the file search unit 240 may search for log information to which access has been requested from the log information storage unit 240, and transmit the found log information to the client module 110.

For the operation, the file search unit 220 may be configured to include a metadata search unit 222, a security level checking unit 224, and a notification unit 226.

If it receives a file access request for accessing a specific file from the client module 110, the security level checking unit 224 controls the metadata search unit 222 to search for metadata corresponding to the file to which access has been requested, from the metadata storage unit 230, and transfer the found metadata to the security level checking unit 224.

The security level checking unit 224 checks the security level of the file from the found metadata. If the security level of the file is equal to or higher than a predetermined security level, the security level checking unit 224 may control the notification unit 226 to notify the file's owner that a request for accessing the corresponding file has been made.

The notification unit 226 searches for information about the file's owner from the user information storage unit 250, and notifies the found file's owner that a request for accessing the file has been made. The information about the file's owner may include the file owner's ID and the file owner's contact information, such as the file owner's mobile phone number and the file owner's E-mail address, and the notification unit 226 may notify the file's owner by a text message or E-mail.

If the security level of the file is lower than the predetermined security level, the security level checking unit 224 stores access information of the file as log information such that the file's owner can search for the log information. The log information is not information acquired by monitoring the state of the OS or system, but log information associated with file data.

FIG. 2 shows only the components of the file management server 120 for distributively storing a file received from the client module 110 and managing the security level of the file, however, the file management server 120 may be configured to further include other function modules.

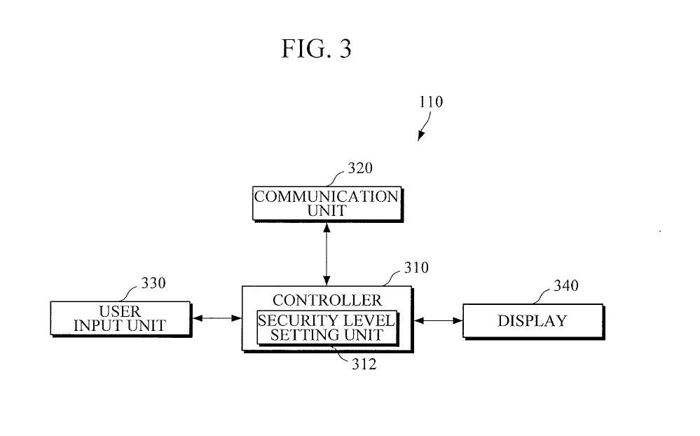

FIG. 3 is a diagram illustrating an example of the client module 110.

Referring to FIG. 3, the client module 110 includes a controller 310, a communication unit 320, a user input unit 330, and a display 340.

The controller 310 may control the operation of the communication unit 320, the user input unit 330, and the display 340. The controller 310 may perform a function of reading and writing files, and also allocate security levels to files. The controller 310 includes a security level setting unit 312 for allocating a security level according to a user input signal. For example, the security level setting unit 312 provides a user interface screen for allowing a user to set a security level of a file, through the display 350, and may allocate a security level designated by a user input signal for setting a security level, the user input signal received through user input unit 330. The security level setting unit 312 may receive a user interface screen for allowing a user to set a security level, from the file management server 120, and provide the user interface screen through the display 350. The communication unit 320 communicates with the file management server 120 and the plurality of chunk servers 130-1 through 130-n. The communication unit 320 may transmit a file to which a security level has already been allocated, to the file management server 120.

The user input unit 330 receives a user input signal and transfers the user input signal to the controller 310. The user input unit 330 may be a keypad, a touch pad, or a touch screen.

The display 340 is a display device for displaying the results of processing by the controller 310. The client module 110 may be configured to include additional modules for performing different functions, other than the components shown in FIG. 3.

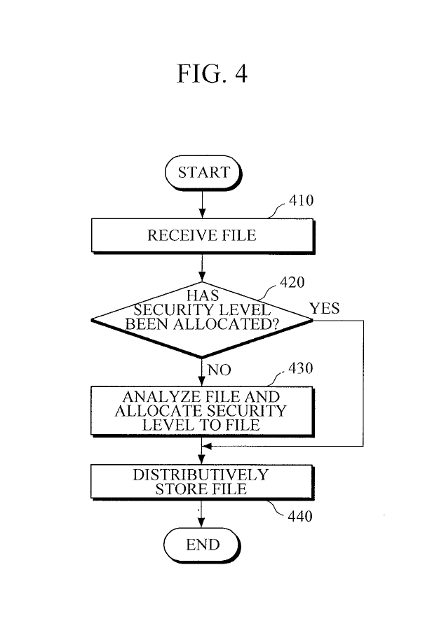

FIG. 4 is a flowchart illustrating a file storing process for ensuring the security of files in a cloud computing environment.

Referring to FIGS. 1 and 4, the file management server 120 receives a file that is requested to be stored, from the client module 110 (410).

Then, the file management server 120 determines whether the file has been allocated a security level (420).

If the file has already been allocated a security level, the file management server 120 distributively stores the file in a plurality of chuck servers (440). At this time, the file management server 120 may decide locations at which the file is to be distributively stored, create metadata including the decided locations and the security level of the file, store the metadata, and then distributively store the file in the locations.

Meanwhile, if the file has been allocated no security level, the file management server 120 analyzes the file to allocate an appropriate security level to the file (430). For example, the file management server 120 may determine whether the file includes a predetermined security keyword, and allocate, if the file includes the predetermined security keyword, a security level “high” to the file.

Then, the file management server 120 may distributively store the file in a plurality of chunk servers (440). Also, the file management server 120 may create metadata including security level information of the received file, information about locations at which the file has been distributively stored, and information about the file's owner, and store and manage the metadata.

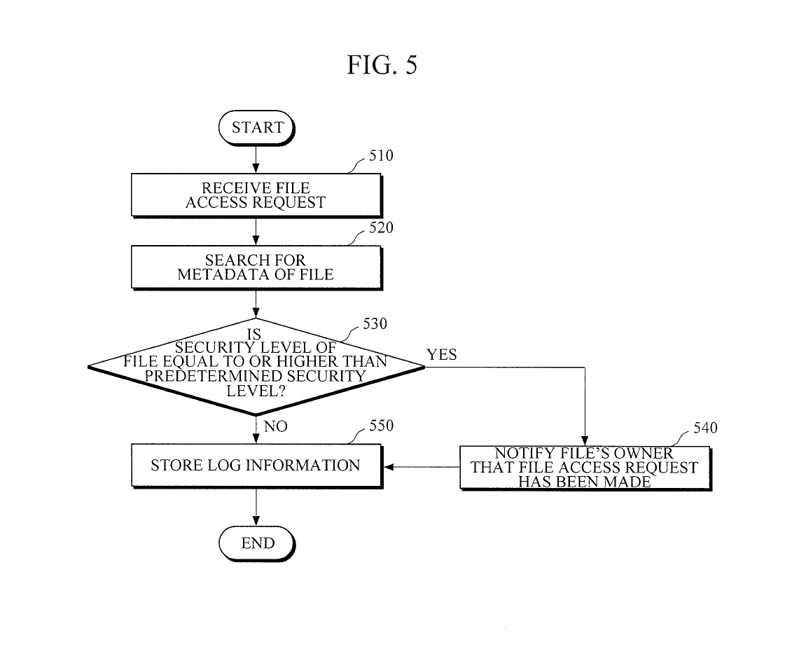

FIG. 5 is a flowchart illustrating a file read process for ensuring the security of a file in a cloud computing environment.

Referring to FIGS. 1 and 5, if the file management server 120 receives a file access request (510), the file management server 120 searches for metadata of a file corresponding to the file access request (520).

If the security level of the file is equal to or higher than a predetermined security level (530), the file management server 120 may notify the file's owner that a file access request for accessing the file has been made (540). Then, the file management server 120 may store and manage log information about the file (550).

If the security level of the file is lower than the predetermined security level, the file management server 120 may store access information of the file as log information (550). Thereafter, if a log information access request is received from the client module 110 which the file's owner uses, the file management server 120 may search for the log information and transmit the found log information to the client module 110.

According to the examples described above, by providing a system for allowing a user to recognize who accesses his or her data and when access to his or her data is made by managing the genealogy of the user's important data, like a system for allowing depositors to check their bank statements by managing transactions related to depositing into and withdrawing from their accounts, the user can safely use data stored in a cloud computing environment. Also, it is possible to notify a user as soon as access to his or her important data is made, like notifying a credit card's owner by a SMS message, etc. when the credit card is used. Further, it is possible to automatically designate a security level of a file that is to be stored by parsing the file using predetermined security keywords.

Accordingly, by designating a security level of a data file according to a degree of importance of the data file and performing data-based file management is it possible to effectively ensure the security of personal information in a cloud computing environment. Also, it is possible to allow users to recognize leakage or misuse of files requiring a high level of security. Also, by designating a security level of a file according to a degree of importance of the file and notifying, when access to an important file is made, the file's owner, efficient file management is possible.

The present invention can be implemented as computer-readable code in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as used in Internet transmission. In addition, the computer-readable recording medium may be distributed to computer systems over a network, in which computer-readable code may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A file management server comprising:
a file registration unit configured to store a file in one or more servers, and to manage a security level of the file; and
a file search unit configured to receive a file access request from a client module, to check a security level of a file corresponding to the file access request, to notify, if the security level of the file is equal to or higher than a predetermined security level, the file's owner that a request for accessing the file has been made.

2. The file management server of claim 1, wherein the file registration unit checks whether the security level has been set for the requested file, when no security level has been set for the file, inspects whether the file contains predetermined security keywords, determines the security level of the file according to the result of the inspection, and creates and manages metadata including the security level of the file.

3. The file management server of claim 1, wherein if the security level has been set for the requested file, the file registration unit creates and manages metadata including the security level of the file.

4. The file management server of claim 1, further comprising a metadata storage unit configured to store metadata including security level information of a received file, information about locations at which the received file is to be stored, and information about the received file's owner.

5. The file management server of claim 4, wherein the file search unit searches for, if a file access request for a specific file is received, metadata of the file, and checks a security level of the file from the metadata.

6. The file management server of claim 1, further comprising a user information storage unit that stores contact information of the file's owner,
wherein the file search unit searches for, if the security level of the file is equal to or higher than a predetermined security level, the contact information of the file's owner from the user information storage unit, and notifies the file's owner that a request for accessing the file has been made, using the contact information of the file's owner.

7. The file management server of claim 6, wherein the file search unit writes a log whenever a file is accessed.

8. The file management server of claim 7, further comprising a log information storage unit that stores file access history,
wherein the file search unit searches for, if a request for access information of the file from the client module is received, log information of the file from the log information storage unit, and transmits the found log information to the client module.

9. The file management server of claim 5, wherein whenever the file access request is received from the client module, the file search unit checks a security level of the file corresponding to the file access request from the metadata storage unit.

10. The file management server of claim 6, wherein the contact information of the file's owner comprises a phone number and/or an email address.

11. A file management method comprising:
checking, if a file access request is received, a security level of a file corresponding to the file access request; and
notifying, if the security level of the file is equal to or higher than a predetermined security level, the file's owner that a request for accessing the file has been made.

12. The file management method of claim 11, further comprising managing a security level of a file received from a client module.

13. The file management method of claim 12, wherein the managing of the security level of the file received from the client module, comprises:
checking whether the security level has been set for the requested file;
inspecting whether the file contains the predetermined security keywords when no security level has been set;
determining the security level of the file according to the result of the inspection;
deciding locations at which the file is to be stored;
creating metadata including the security level of the file and the locations at which the file is to be stored, and storing the metadata; and
storing the file at the locations at which the file is to be stored.

14. The file management method of claim 13, further comprising analyzing the received file to check information about the received file's owner, wherein the metadata include the information about the received file's owner.

15. The file management method of claim 13, wherein the determining of the security level of the file according to the result of the inspection comprises:
inspecting whether the file contains the predetermined security keywords; and
setting, if the file contains the predetermined security keywords, the security level of the file as a level at which the file's owner needs to be notified when a file access request is received.

16. The file management method of claim 12, wherein the managing of the security level of the file received from the client module comprises:
checking whether the security level has been set for the requested file;
deciding, if the security level has been set for the requested file, the locations at which the file is to be stored;
creating metadata including the security level of the file and the locations at which the file is to be stored, and storing the metadata; and
storing the file at the locations at which the file is to be stored.
